(19) United States
(12) Patent Application Publication
(10) Pub. No.: US 2006/0070784 A1
(43) Pub. Date: Apr. 6, 2006

(54) Electrically-assisted cycle having physical strength promoting function

(76) Inventor: Yoshimasa Tahara, Shimoniikawa-gun (JP)

Correspondence Address: ARENT FOX PLLC, 1050 CONNECTICUT AVENUE, N.W., SUITE 400, WASHINGTON, DC, 20036, US

(21) Appl. No.: 10/540,537

(22) PCT Filed: Dec. 2, 2004
(86) PCT No.: PCT/JP04/17914

§ 371 Date: Jun. 24, 2005

(30) Foreign Application Priority Data
Apr. 7, 2004 (JP) 2004-113340

(51) Int. Cl. B62M 23/02

(52) U.S. Cl. 180/205

(57) ABSTRACT

In an electrically assisted cycle, a rotor shaft (61a) of an electric generator/motor (61) is connected to a transmitting device (M) mounted between a crankshaft (17) and a rear wheel (10r); a clutch (46) is incorporated in a transmitting path between the electric generator/motor (61) and the rear wheel (10r) to enable the transmitting path to be opened or closed as desired; and a mode switchover means (91, 92, 99) is mounted, which is capable of being switched over, as desired, between an electrically assisting mode in which a power is generated in the electric generator/motor (61) and a charging mode in which an electric power generated in the electric generator/motor (61) due to a back load to the rotor shaft (61a) is charged in the battery (90). Thus, if the mode switchover means is switched over to the charging mode in a disconnected state of the clutch (46), the training for promoting the physical strength can be conducted with the cycle remaining disposed in a fixed position, while conducting the charging of the battery (90) from the electric generator/motor (61). Namely, it is possible to provide the electrically assisted cycle having a physical strength promoting function, which can be used not only for the nimble movement of a rider, but also as a fixed-position type training machine for providing the promotion of the physical strength of the rider by applying a load to pedals in a stopped state of the cycle.

### TECHNICAL FIELD

The present invention relates to an electrically-assisted cycle having a physical strength promoting function, which can be used as a fixed-position type exercise device in which a pedal driving force of a rider is assisted by an electric power of a battery during the usual traveling of the cycle, and a load is applied to pedals to provide the promotion of a rider's physical strength in a stopped state of the cycle.

### BACKGROUND ART

There is an electrically-assisted cycle conventionally known as disclosed in, for example, the following Patent Document 1, which comprises a transmitting device which enables the transmission of a driving force to a rear wheel from a crankshaft having pedals driven by a rider, a battery, and a motor having a rotor shaft connected to the transmitting device and transmitting to the transmitting device a power generated by the supplying of an electric power from the battery in accordance with a pedal load.

Patent Document 1: Japanese Patent Application Laid-open No.10-167160

### DISCLOSURE OF THE INVENTION PROBLEMS TO BE SOLVED BY THE INVENTION

The conventional electrically-assisted cycle is used exclusively only for the nimble movement of a rider, and it is not taken into consideration that this cycle is used as a fixed-position type training machine for promoting the rider's physical strength.

It is an object of the present invention to provide an electrically-assisted cycle having a physical strength promoting function, which can be used not only for the nimble movement of a rider but also as a fixed-position type training machine for promoting the rider's physical strength by applying a load to pedals in a stopped state of the cycle.

### MEANS FOR SOLVING THE PROBLEMS

To achieve the above object, according to a first aspect and feature of the present invention, there is provided an electrically-assisted cycle having a physical strength promoting function, comprising a transmitting device which connects a crankshaft having pedals driven by a rider and a rear wheel to each other, a battery, an electric generator/motor having a rotor shaft connected to the transmitting device, a mode switchover means capable of being switched over, as described, between an electrically assisting mode in which a power is generated in the electric generator/motor by supplying of an electric power from the battery and a charging mode in which the electric power generated in the electric generator/motor due to a back load to the rotor shaft is charged in the battery, and a clutch capable of opening and closing a transmitting path between the electric generator/motor and the rear wheel as desired.

The mode switchover means corresponds to a mode switchover drive circuit 91, an assisting/charging mode changeover switch 92 and an electronic control circuit system 99 in an embodiment of the present invention which will be described hereinafter.

According to a second aspect and feature of the present invention, in addition to the first feature, an electrically-assisted cycle having a physical strength promoting function further includes a pedal load adjusting means capable of adjusting a pedal load provided by the rider by increasing or decreasing the amount of power charged in the battery from the electric generator/motor, when the mode switchover means is switched over to the charging mode.

The pedal load adjusting means corresponds to a pedal load adjusting dial 93 of the present inventionwhichwill be described hereinafter.

According to a third aspect and feature of the present invention, in addition to the first or second feature, a vehicle body shell is mounted to a vehicle body frame to define a cabin for accommodation of the rider.

### EFFECT OF THE INVENTION

With the first feature of the present invention, when the clutch is brought into a disconnected state in the stopped state of the cycle and the mode switchover means is switched over to the side for the charging mode, the battery can be charged from the electric generator/motor by driving the electric generator/motor from the pedals without driving of the rear wheel, whereby the promotion of the rider's physical strength can be provided by the resulting load. Therefore, this cycle can be used as a fixed-position type training machine for promoting the physical strength without limitation of the placing area to a garage and a garden of a rider's house or the like, and moreover, a kinetic energy of the rider is converted into an electric power to be charged in the battery, leading to no wastefulness of energy.

When the clutch is brought into a connected state and the mode switchover means is switched over to the side for the electrically assisting mode, the electric generator/motor is supplied with an electric power from the battery to output an assisting power to the transmitting device during traveling of the cycle caused by driving the pedal by the rider, and hence, the pedals can be driven lightly.

Even during traveling of the cycle, if the mode switchover means is switched over to the charging mode, the training for the promotion of the physical strength can be conducted simultaneously with the charging of the battery.

With the second feature of the present invention, during training conducted by the rider, the pedal load can be adjusted as desired in accordance with the rider's physical strength, the degree of fatigue and the like by increasing or decreasing the amount of power charged in the battery from the electric generator/motor, whereby the training can be conducted comfortably without strain.

Further, with the third feature of the present invention, the rider conducts the training in the cabin within the vehicle body shell and hence, can conduct the training comfortably even outdoors in a cold season or in wind and rain weathers.

### BRIEF DESCRIPTION OF THE DRAWINGS

FIG. 1 is a side view showing a three-wheel type electrically assisted cycle according to the present invention with a vehicle body shell removed. (Embodiment 1)

FIG. 2 is afront view of the three-wheel type electrically assisted cycle. (Embodiment 1)

FIG. 3 is a front view of the three-wheel type electrically assisted cycle. (Embodiment 1)

FIG. 4 is a plan view of an area around a rear wheel suspension in FIG. 1. (Embodiment 1)

FIG. 5 is a sectional view taken along a line 5-5 in FIG. 4. (Embodiment 1)

FIG. 6 is a sectional view taken along a line 6-6 in FIG. 4. (Embodiment 1)

FIG. 7 is a sectional view taken along a line 7-7 in FIG. 4. (Embodiment 1)

FIG. 8 is a sectional view taken along a line 8-8 in FIG. 5. (Embodiment 1)

FIG. 9 is a sectional view taken along a line 9-9 in FIG. 8. (Embodiment 1)

FIG. 10 is a plan view of a transmitting device of the electrically assisted cycle. (Embodiment 1)

FIG. 11 is a vertical cross-sectional plan view of essential portions, showing a clutch in FIG. 10 in a connected state. (Embodiment 1)

FIG. 12 is a plan view showing the clutch in a disconnected state. (Embodiment 1)

FIG. 13 is a diagram of an electric circuit of the electrically assisted cycle. (Embodiment 1)

FIG. 14 is a side view showing the electrically assisted cycle having the vehicle body shell mounted thereto. (Embodiment 1)

FIG. 15 is a perspective view of the vehicle body shell. (Embodiment 1)

FIG. 16 is a sectional view taken along a line 16-16 in FIG. 14. (Embodiment 1)

FIG. 17 is a sectional view taken along a line 17-17 in FIG. 14. (Embodiment 1)

FIG. 18 is a sectional view taken along a line 18-18 in FIG. 17. (Embodiment 1)

FIG. 19 is a sectional view taken along a line 19-19 in FIG. 18. (Embodiment 1)

FIG. 20 is an exploded perspective view of a floor frame and a floor plate in FIG. 17. (Embodiment 1)

### DESCRIPTION OF REFERENCE NUMERALS AND CHARACTERS

B Electrically assisted cycle having a physical strength promoting function
F Vehicle body frame
M Transmitting device
10r Rear wheel
16 Pedal
17 Crankshaft
46 Clutch
61 Electric generator/motor
91, 92, 99 Mode switchover means
91 Mode switchover drive circuit
92 Assisting/charging mode changeover switch
93 Pedal load adjusting means (pedal load adjusting dial)
99 Electronic control circuit system
105 Vehicle body shell
106 Cabin

### BEST MODE FOR CARRYING OUT THE INVENTION

The mode for carrying out the present invention will now be described by way of preferred embodiment of the present invention shown in drawings.

### Embodiment 1

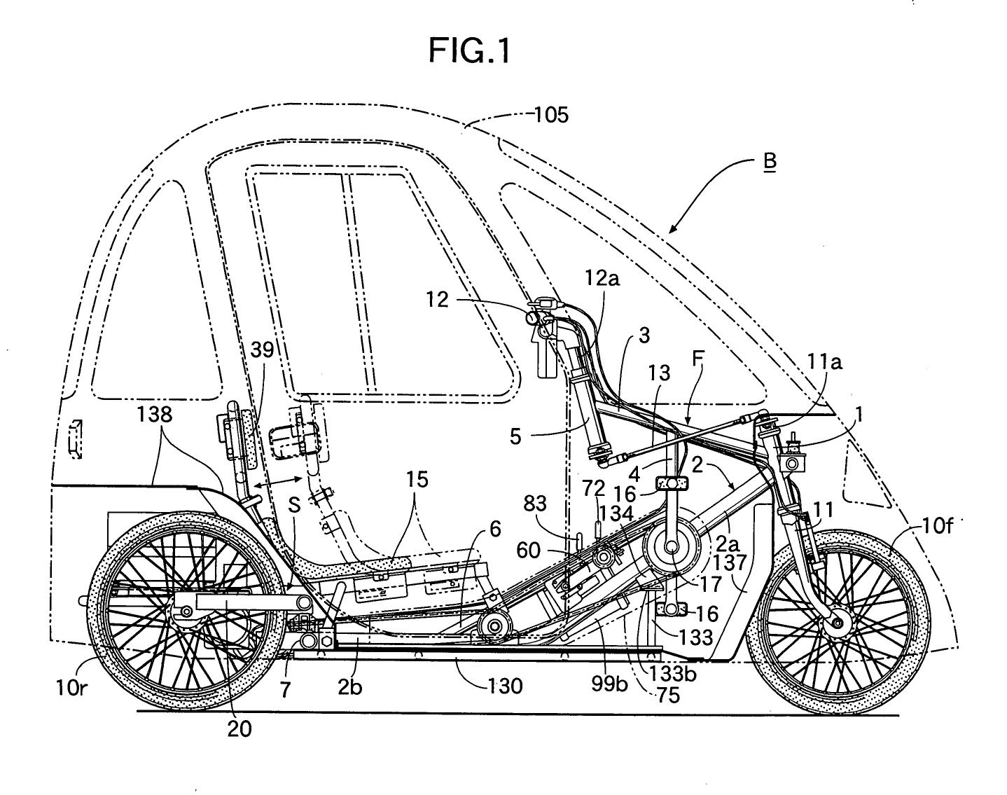

Referring first to FIGS. 1 to 3, a vehicle body frame F for three-wheel type electrically assisted cycle B having a physical strength-promoting function includes a front head pipe 1, a main pipe 2 comprising an inclined section 2a extending obliquely downwards from the front head pipe 1 and a horizontal section 2b extending horizontally rearwards from a rear end of the inclined section 2a, ahandlebar supporting pipe 3 protruding obliquely rearwards and upwards of the main pipe 2 from the front head pipe 1, a first stay 4 which connects the handlebar supporting pipe 3 and the inclined section 2a to each other, a rear head pipe 5 fixedly mounted at a rear end of the handlebar supporting pipe 3, a second stay 6 which connects the first stay 4 and the horizontal section 2b to each other, and a cross pipe 7 extending horizontally and connected perpendicularly to a rear end of the horizontal section 2b. Welded to the cross pipe 7 are a pair of left and right brackets 8, 8 protruding from a rear surface of the cross pipe 7, and a pair of left and right suspension arms 9, 9 protruding perpendicularly to and across the cross pipe 7 outside opposite sides of the brackets 8, 8.

A fork stem 11a integrally and projectingly provided at an upper end of a front fork 11 for supporting a front wheel 10f is rotatably carried on the front head pipe 1, and a handlebar stem 12a coupled to a steering handlebar 12 is rotatably carried on the rear head pipe 5. An upper end of the fork stem 11a and a lower end of the handlebar stem 12a are connected to each other through a link mechanism 13, so that the turning of the steering handlebar 12 can be transmitted to the front fork 11.

A pair of left and right rear wheels 10r, 10r are liftably and lowerably connected to rear ends of the pair of suspension arms 9, 9 of the cross pipe 7 through a rear wheel suspension S, and a saddle 15 is mounted to extend from the second stay 6 to the horizontal section 2b of the main pipe 2. A crankshaft 17 having pedals 16, 16 provided at both of its left and right ends is rotatably carried at an intermediate portion of the inclined section 2a of the main pipe 2.

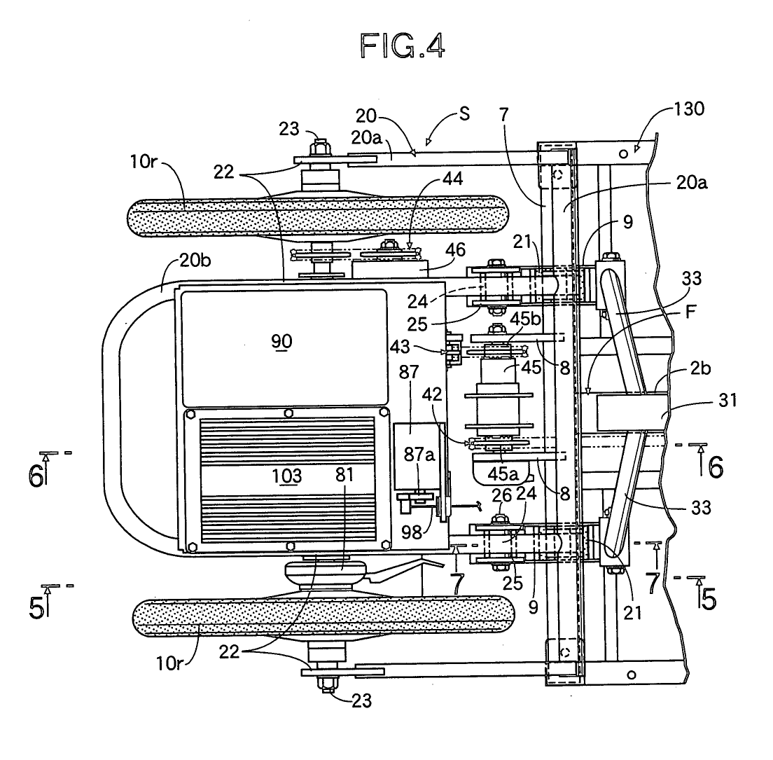

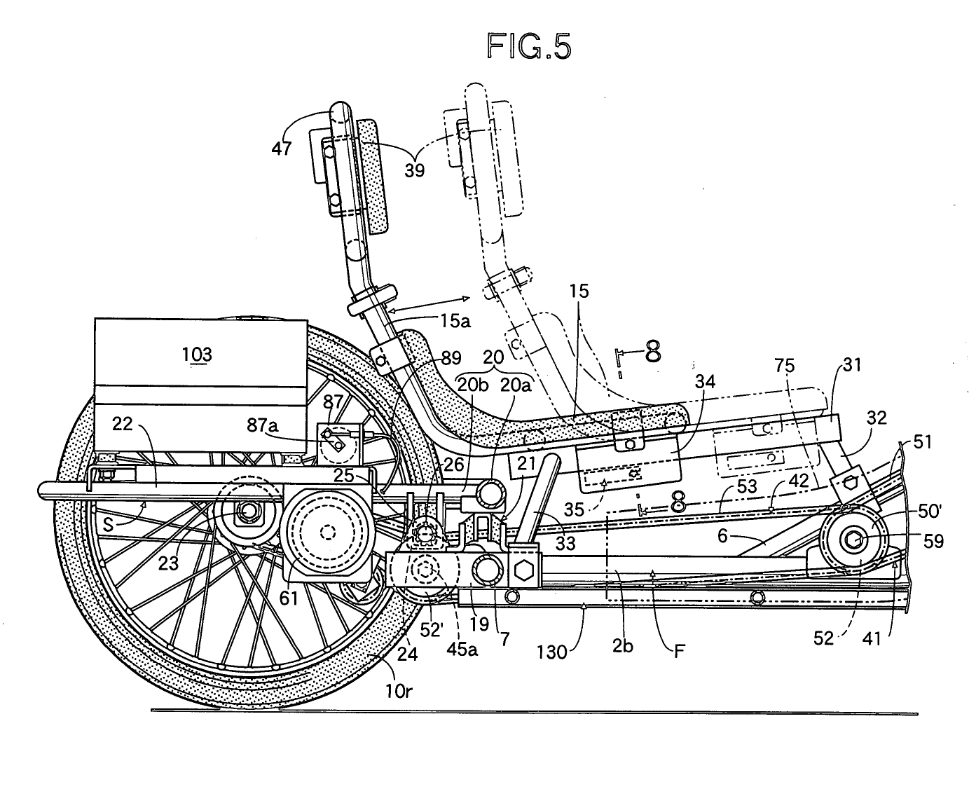

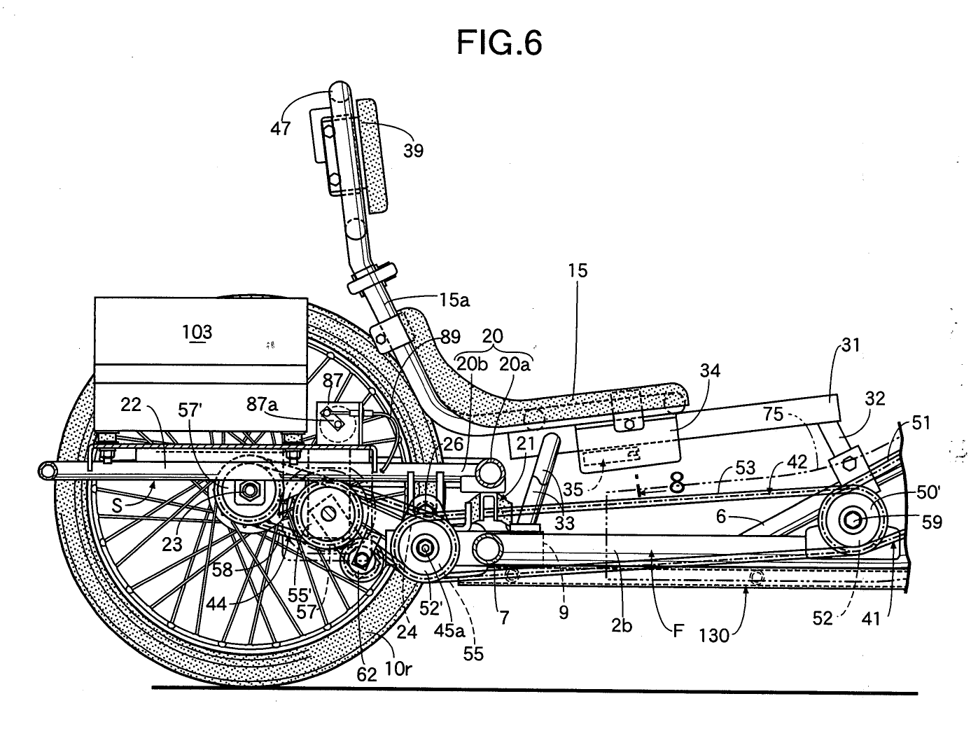

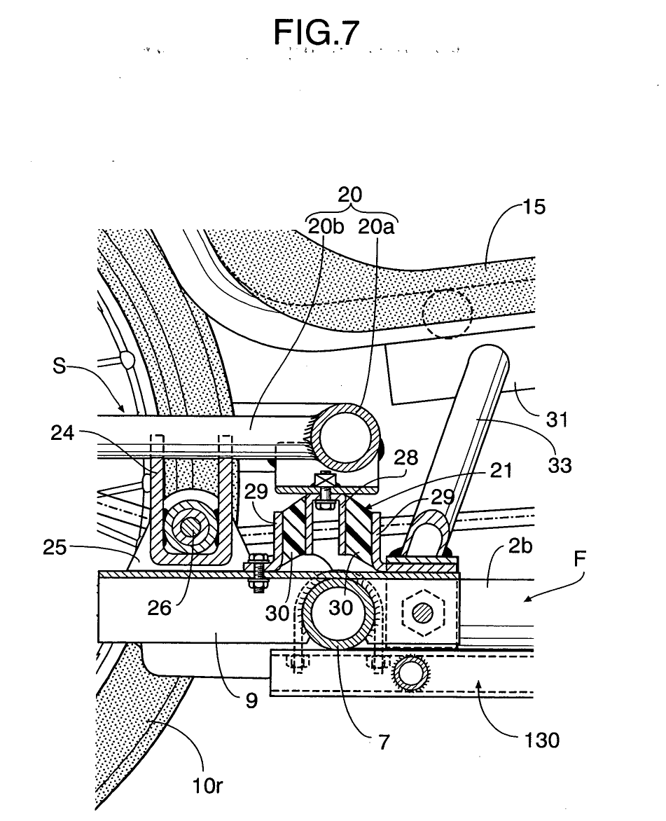

The rear wheel suspension S will be described below with reference to FIGS. 4 to 7.

The rear wheel suspension S is comprised of a swing arm 20 vertically swingably connected to the rear ends of the pair of left and right suspension arms 9, 9 through a pair of left and right pivots 26, 26 coaxially disposed horizontally in a lateral direction, and cushion blocks 21, 21 interposed between the swing arm 20 and the vehicle body frame F disposed below the swing arm 20.

The swing arm 20 comprises an outer arm member 20a having a rectangular U-shape as viewed in a plane and an opening directed rearwards, and an inner arm member 20b which is disposed in the outer arm member 20a and has a rectangular U-shape as viewed in a plane with an opening directed forwards and is welded at its opposite ends to a front portion of the outer arm member 20a. A pair of left and right rear forks 22, 22 are formed by mutually adjoining arm portions of the outer and inner arm members 20a and 20b. Namely, the swing arm 20 is formed with the left and right rear forks 22, 22 integrally connected to each other. Axles 23, 23, on which hubs of the left and right rear wheels 10r, 10r are rotatably carried respectively, are secured to the rear forks 22, 22.

The inner arm member 20b has a pair of left and right first bearing portions 24, 24 arranged coaxially and provided at locations close to its front end to protrude downwards. The left and right suspension arms 9, 9 disposed below the inner arm member 20b are provided at the rear ends with a pair of left and right second bearing portions 25, 25 which protrude upwards and axially adjoin the first bearing portions 24, 24, respectively. The adjoining first and second bearing portions 24 and 25 are relatively rotatably connected to each other by the pivots 26, 26, whereby the swing arm 20 can be vertically swung about the pivots 26, 26. In this case, each of the first bearing portions 24 and each of the second bearing portions 25 are disposed so that each of the pivots 26 carried on them is located in an inner region between the left and right rear wheels 10r, 10 r.

The cushion block 21 is interposed in front of each of the pivots 26 between the inner arm member 20b and the suspension arm 9 vertically opposed to each other.

Each of the cushion blocks 21 comprises a rectangular U-shaped upper mounting member 28 having an opening directed downwards, a pair of front and rear lower L-shaped lower mounting members 29, 29 having rising portions opposed to each other with the upper mounting member 28 interposed therebetween, and a cushion member 30 made of an elastic material such as a rubber and baked to longitudinally opposed surfaces of the upper mounting member 28 and the lower mounting members 29, 29 to elastically connect the upper mounting member 28 and the lower mounting members 29, 29 to each other. The upper mounting member 28 is secured to a lower surface of the inner arm member 20b, and the lower mounting members 29, 29 are secured to an upper surface of the suspension arm 9, in both cases, by bolts or the like.

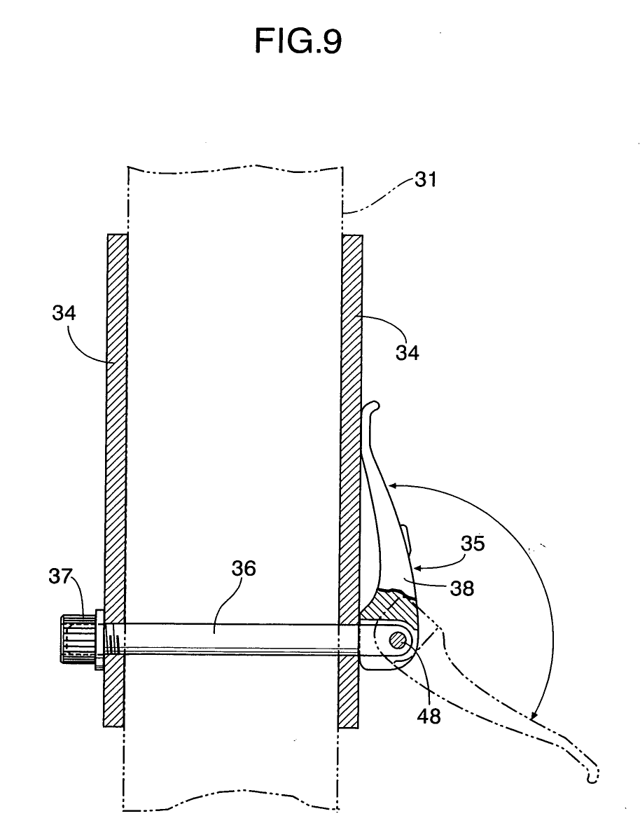

A structure of mounting of the saddle 15 to the main pipe 2 will be described below with reference to FIGS. 1, 5, 8 and 9.

A single saddle guide rail 31 for supporting the saddle 15 is disposed above the horizontal section 2b of the main pipe 2 to extend longitudinally. The saddle guide rail 31 is integrally provided with a single front leg 32 protruding from a lower surface of its front end, and a pair of left and right rear legs 33, 33 protruding downwards from a side face of its rear end. The front leg 32 is secured to the second stay 6, and the rear legs 33, 33 are secured to front ends of the pair of left and right suspension arms 9, 9, in both cases, by bolts. The saddle guide rail 31 mounted in this manner is provided with a gradient upward in a forward direction.

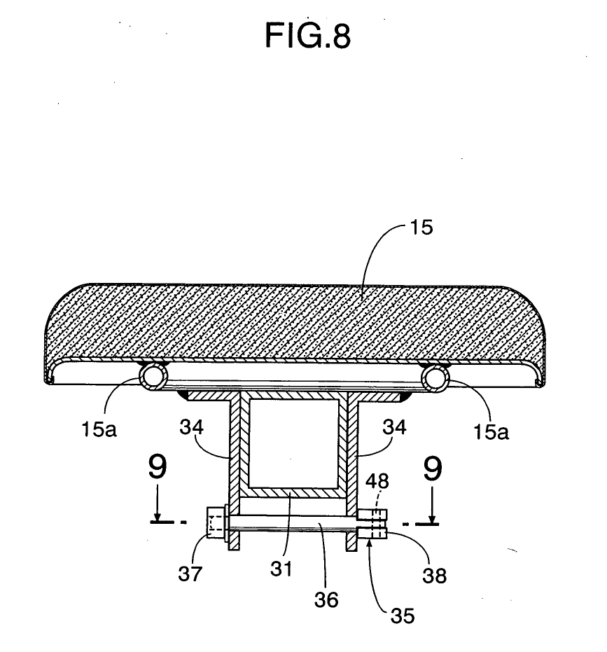

The saddle guide rail 31 is formed of a single pipe square in section, as clearly shown in FIG. 8. A saddle frame 15a secured to a bottom plate of the saddle 15 is longitudinally slidably laid on an upper surface of the saddle guide rail 31, and a pair of left and right clamping plates 34, 34 fixedly mounted on the saddle frame 15a are longitudinally slidably disposed on opposite sides of the saddle guide rail 31. Lower ends of the clamping plates 34, 34 protrude below the saddle guide rail 31, and the saddle 15 is fixed to the saddle guide rail 31 by clamping these lower ends against each other by a damper 35. The steering handlebar 12 is disposed in front of and above the saddle 15 fixed in this manner, and the crankshaft 17 is disposed so that its rotational axis is located below the steering handlebar 12 and in front of and above the saddle 15.

The clamper 35 comprises a clamp bolt 36 extending laterally through lower ends of the clamping plates 34, 34, an adjusting nut 37 which abuts against an outer side of the lower end of one of the clamping plates 34 and with which a tip end of the clamp bolt 36 is threadedly engaged, and a cam lever 38 mounted to a base end of the clamp bolt 36 through a pivot 48 extending in a diametrical direction of the clamp bolt 36. The cam lever 38 tightens the clamping plates 34, 34 to each other upon falling of the cam lever 38 in a direction perpendicular to the clamp bolt 36, and releases the tightening of the clamping plates 34 upon raising-up of the cam lever 38 in an axial direction of the clamp bolt 36.

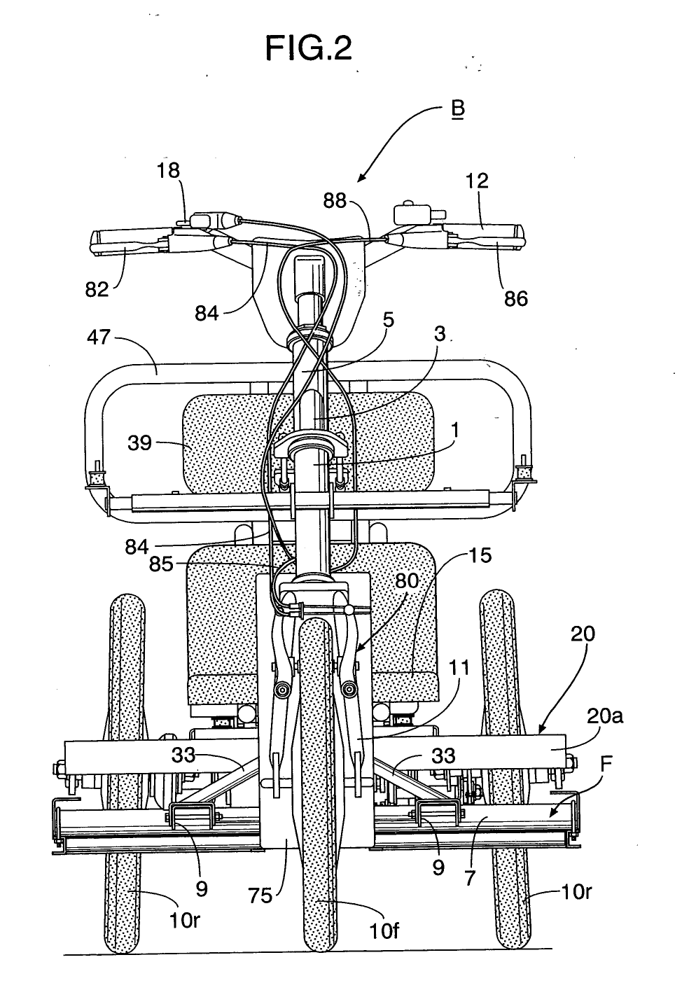

As shown in FIGS. 2, 3 and 5, the saddle frame 15a secured to the bottom plate of the saddle 15 is bent to rise upwards aback of the saddle 15, and a back pad 39 is vertically adjustably mounted to the rising portion of the saddle frame 15a. An oblong grab rail 47 made of a pipe and protruding laterally outside the back pad 39 is coupled to the saddle frame 15a by welding or the like. The grab rail 47 is grasped by a rider, when the rider tries to get on and off the saddle 15 or to wheel the electrically assisted cycle B by hands.

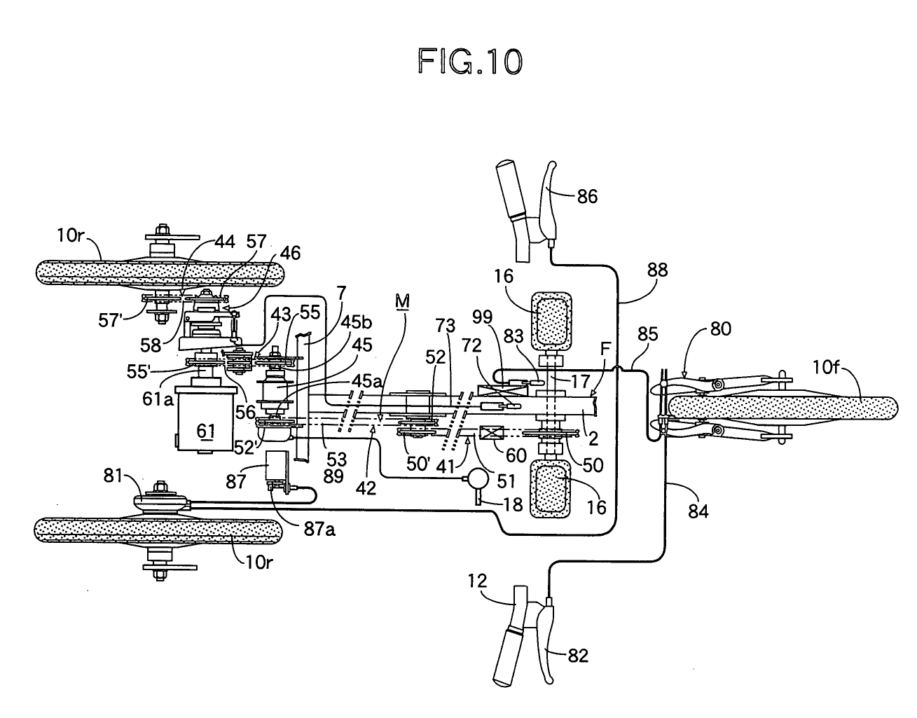

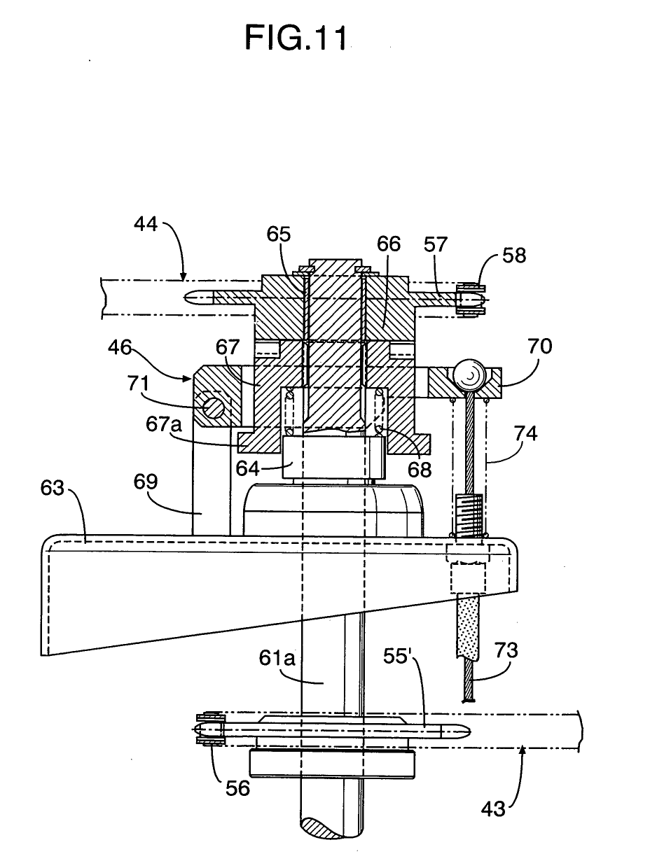

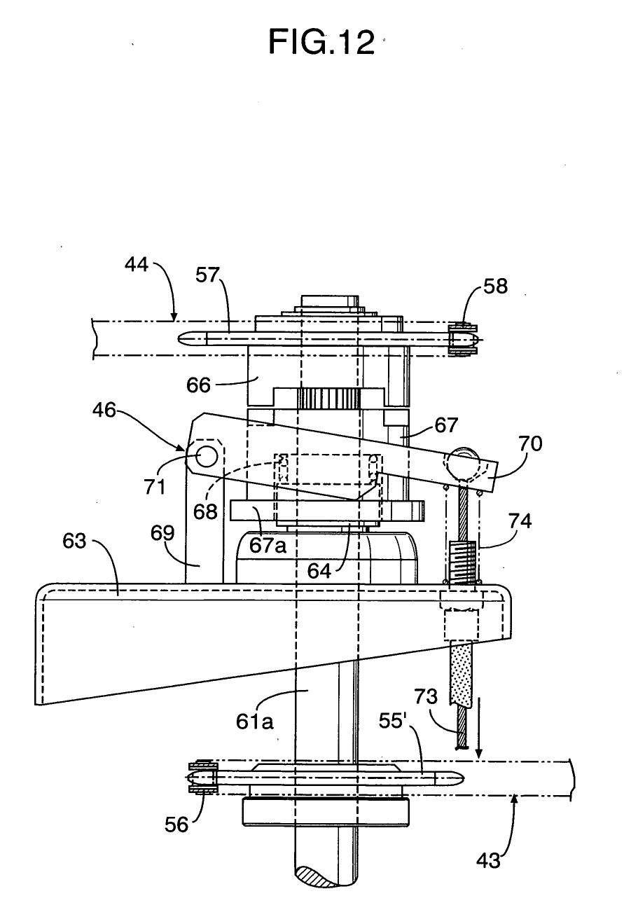

A transmission system M connecting the crankshaft 17 and the rear wheel 10r to each other will be described below with reference to mainly FIGS. 10 to 12.

The transmitting system M is comprised of a first chain gearing device 41, a second chain gearing device 42, amulti-stage transmission 45 having a free wheel, a third gearing device 43, an electric generator/motor 61, a clutch 46 and a fourth gearing device 44, which are connected sequentially to one another in the mentioned order from the side of the crankshaft 17.

The first gearing device 41 is comprised of a first chain 51 wound around a first driving sprocket 50 fixedly mounted on the crankshaft 17 and around a first follower sprocket 50′ rotatably carried at a front end of the horizontal section 2b (see FIG. 1) of the main pipe 2. Apedal load sensor 60 is mounted to the main pipe 2 for detecting a load applied to the crankshaft 17, i.e., a pedal load from the degree of tension of the first chain 51.

The second chain gearing device 42 is comprised of a second chain 53 wound around a second driving sprocket 52 fixedly mounted on a transmitting shaft 59 adjacent the first follower sprocket 50′ and around a second follower sprocket 52′ fixedly mounted on an input shaft 45a of the transmission 45 mounted to the brackets 8, 8 of the cross pipe 7 (see FIG. 1).

The transmission 45 includes and input shaft 45a and an output shaft 45b disposed coaxially with each other, multi-stage transmitting gear trains capable of connecting the input shaft 45a and the output shaft 45b to each other, and a free wheel enabling the transmission only in one direction from the input shaft 45a to the output shaft 45b. The free wheel blocks a back load to the crankshaft 17 and hence, can be also mounted on the first chain gearing device 41 or the second chain gearing device 42.

The third chain gearing device 43 is comprised of a third chain 56 wound around a third driving sprocket 55 fixedly mounted on the output shaft 45b of the transmission 45 and around a third follower sprocket 55′ fixedly mounted on a rotor shaft 61a of the electric generator/motor 61 mounted to the swing arm 20, so that the third chain 56 is resiliently tensioned by a tensioner 62. The tensioner 62 may be omitted, when any one of the output shaft 45a of the transmission 45 and the rotor shaft 61a of the electric generator/motor 61 is disposed coaxially with the pivots 26, 26 of the swing arm 20.

The clutch 46 includes a bracket 63 which is fixed to the swing arm 20 and on which an intermediate portion of the rotor shaft 61a of the electric generator/motor 61 is rotatably carried, a cylindrical retainer 64 axially non-movably mounted on the rotor shaft 61a adjacent an outer side of the bracket 63, a stationary dog clutch member 66 rotatably and axially non-movably mounted to a tip end of the rotor shaft 61a with a bearing bush 65 interposed therebetween, a movable dog clutch member 67 which is slidably spline-fitted over the rotor shaft 61a between the retainer 64 and the stationary dog clutch member 66 and is capable of being brought into and out of engagement with the stationary dog clutch member 66, and a clutch spring 68 mounted under compression between the retainer 64 and the movable dog clutch member 67 to bias the movable dog clutch member 67 in a direction of engagement with the stationary dog clutch member 66. A rear end of the movable dog clutch 46 is also slidably fitted over an outer peripheral surface of the retainer 64, and a flange 67a is formed around an outer periphery of such rear end. An annular release lever 70 is mounted at its base end on a support shaft 69 rising on an outer side of the bracket 63 by a pivot shaft 71 to surround the movable dog clutch member 67, so that it is opposed to a front surface of the flange 67a to be able to abut against such front surface. A clutch wire 73 connected to a clutch lever 72 supported on the steering handlebar 12 or the vehicle body frame F in the vicinity of the steering handlebar 12 is connected to a tip end of the release lever 70. A return spring 74 is mounted under compression between the release lever 70 and the bracket 63 to bias the movable dog clutch member 67 toward the stationary dog clutch member 66.

The clutch lever 72 is usually disposed in a turned-on position in which the clutch wire 73 has been loosened and hence, the rotation of the rotor shaft 61a can be transmitted via the movable dog clutch member 67 to the stationary dog clutch member 66 by retaining the release lever 70 in a position of engagement with the stationary dog clutch member 66 by biasing forces of the return spring 74 and the clutch spring 68. Namely, the clutch 46 is in a connected state. On the other hand, when the clutch lever 72 is operated to a turned-off position to pull the clutch wire 73, the release lever 70 urges the flange 67a to pull the movable dog clutch member 67 away from the stationary dog clutch member 66, thereby cutting off the transmission of the rotation from the rotor shaft 61a to the stationary dog clutch member 66. Namely, the clutch 46 is brought into a disconnected state.

The fourth chain gearing device 44 is comprised of a fourth chain 58 wound around a fourth driving sprocket 57 integrally formed on the stationary dog clutch member 66 and around a fourth follower sprocket 57′ coupled to the hub of any one of the rear wheels 10r, e.g., the left rear wheel 10r in the illustrated embodiment. Therefore, the connection and disconnection of the clutch 46 control the connection and disconnection of the rotor shaft 61a and the fourth driving sprocket 57 to and from each other.

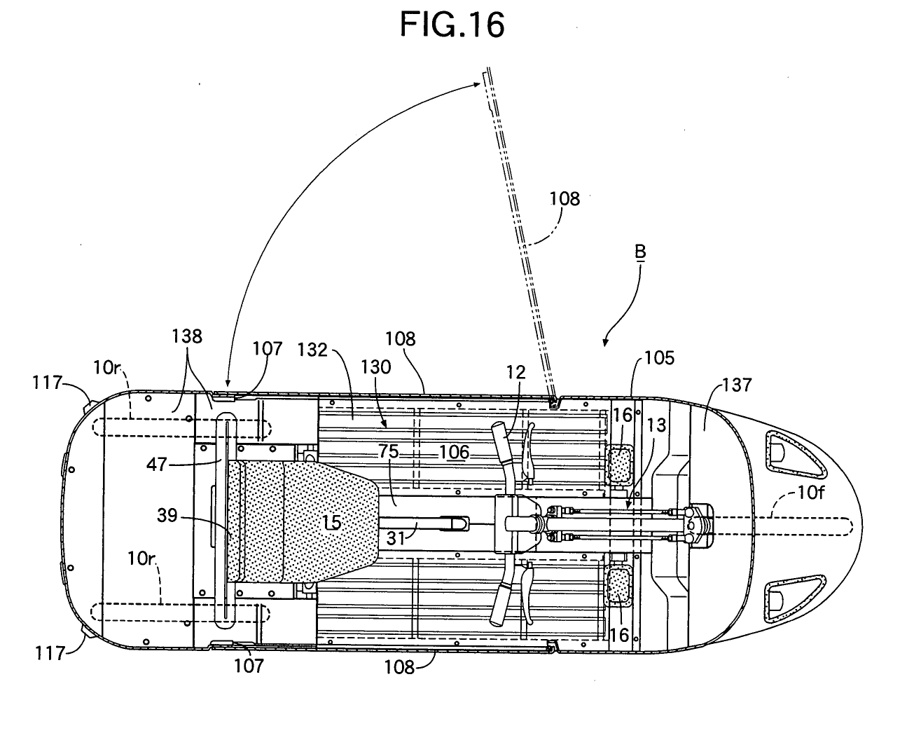

The whole of the first chain gearing device 41 and a front half of the second chain gearing device 42 are covered with a chain cover 75 (see FIGS. 1 and 16) secured to the main pipe 2. Therefore, a rider sitting on the saddle 15 is protected from the contact with the first and second chain gearing devices M.

A brake device will be described below with reference to FIGS. 2, 4 and 10.

A caliper-type front brake 80 is mounted on the front wheel 10f for braking the front wheel 10f, and a drum-type rear brake 81 is mounted on the rear wheel 10r opposite from the fourth chain gearing device 44 for braking this rear wheel 10r. A front brake lever 82 mounted to the steering handlebar 12 adjacent a right grip and a parking lever 83 mounted to a front portion of the main pipe 2 are connected to an operating portion of the front brake 80 through a first brake wire 84 and a second brake wire 85, respectively. Therefore, the front brake 80 can be actuated by operating any one of the front brake lever 82 and the parking lever 83.

A rear brake lever 86 mounted to the steering handlebar 12 adjacent a left grip and an actuating lever 87a of a brake motor 87 mounted to the swing arm 20 are connected to an operating portion of the rear brake 81 through a third brake wire 88 and a fourth brake wire 89, respectively. Therefore,the rear brake 81 can be actuated by operating the rear brake lever 86 or by actuating the brake motor 87.

In FIGS. 2 and 10, reference numeral 18 designates a shift lever for switching-over the transmission 45.

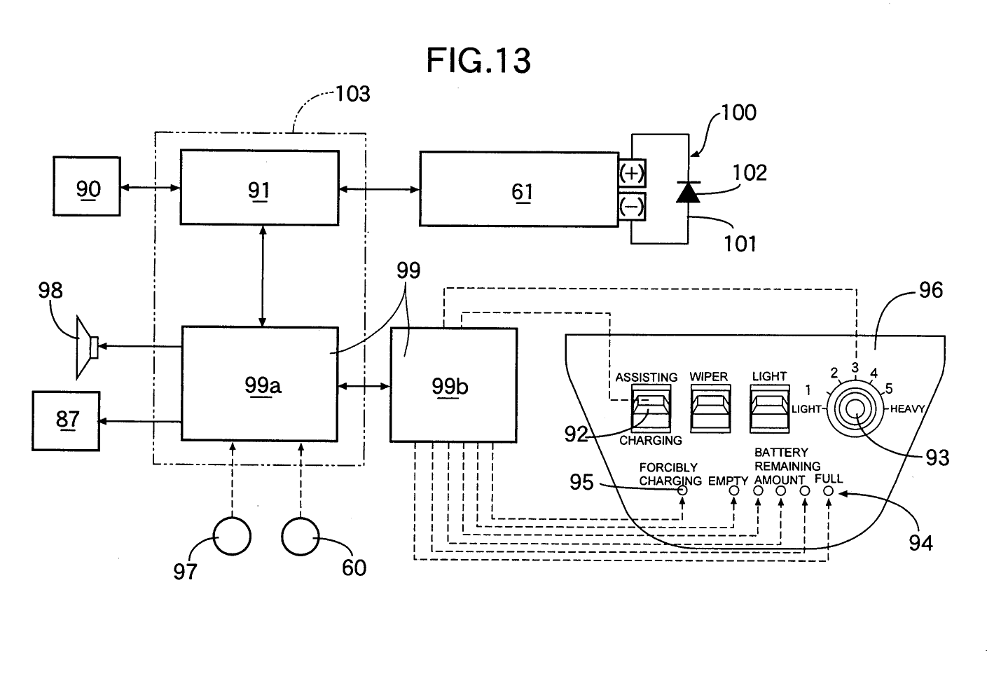

An electric circuit for the electrically-assisted cycle B having the physical strength promoting function will be described below with reference to FIG. 13.

A mode switchover drive circuit 91 for switching-over the delivery and reception of an electric power is interposed between a battery 90 and the electric generator/motor 61. An electronic control circuit system 99 comprises a main control circuit 99a for controlling the mode switchover drive circuit 91 and a subsidiary control circuit 99b for assisting in the operation of the main control circuit 99a, while permitting the delivery and reception of signals between switches and indicators on an operation panel 96.

Particular examples of the switches and indicators mounted on the operation panel 96 are an assisting/charging mode changeover switch 92 for changing over the mode switchover drive circuit 91 from one of an electrically assisting mode and a charging mode to the other, a pedal load adjusting dial 93 for adjusting a pedal load by adjusting the amount of power charged in the battery 90 from the electric generator/motor 61 in the charging mode of the mode switchover drive circuit 91, a plurality of remaining-power indication lamps 94 for indicating a power remaining in the battery 90, a forcibly charging indication lamp 95 for indicating a state in which a power should be forcibly charged in the battery 90 from the electric generator/motor 61, when the power remaining in the battery 90 has been reduced to a value equal to or smaller than a defined value, and so on. The operation panel 96 is mounted to a central portion of the steering handlebar 12.

An output signal from the pedal load sensor 60 is input to the main control circuit 99a, and the amount of power supplied from the battery 90 to the electric generator/motor 61 is controlled in accordance with the pedal load during the assisted traveling.

Further, an output signal from a vehicle speed sensor 97 for detecting a rotational speed of the front wheel 10f or the rear wheels 10r as a vehicle speed is input to the main control circuit 99a, and when the main control circuit 99a determines that the vehicle speed has exceeded a first predetermined value indicating a relatively high speed, the main control circuit 99a actuates a speed warning buzzer 98, and when the main control circuit 99a determines that the vehicle speed has exceeded a second predetermined value larger than first predetermined value, the main control circuit 99a actuates the brake motor 87 to pull the fourth brake wire 89, so that the rear brake 81 is actuated automatically.

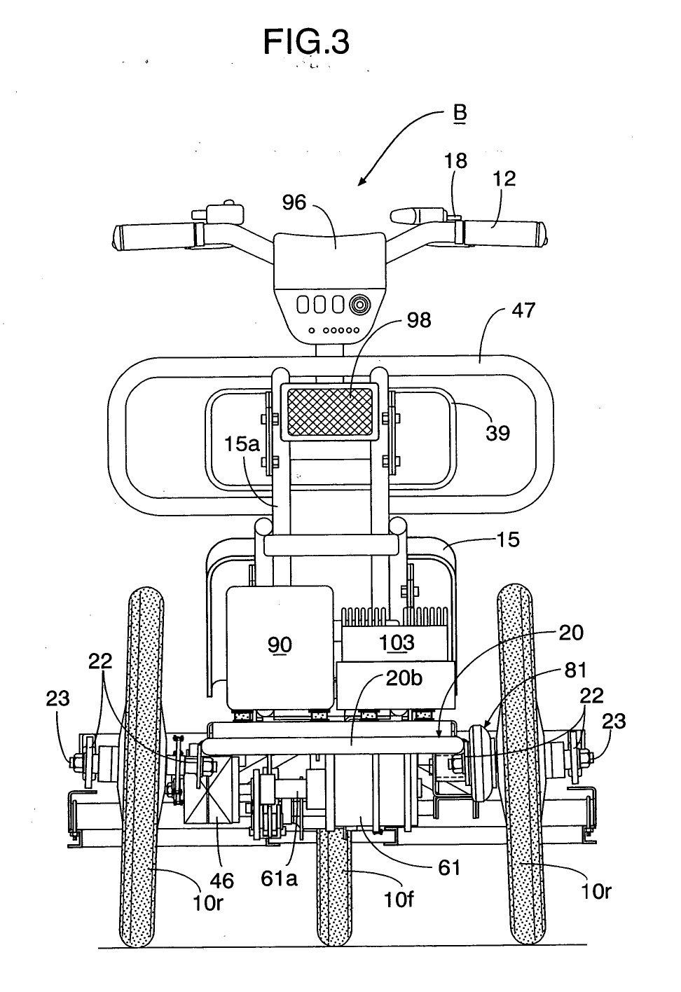

The mode switchover drive circuit 91 and the main control circuit 99a are constructed on the same board to form an electric circuit assembly 103, which is mounted along with the battery 90 on the swing arm 20 with an elastic member interposed therebetween in a region between the left and right rear wheels 10r, 10r, as shown in FIGS. 3 to 5.

On the other hand, the subsidiary control circuit 99b is mounted on a side face (see FIG. 1) of the inclined section 2a of the main pipe 2. The subsidiary control circuit 99b is disposed so that it is covered with the chain cover 75.

It should be noted that the speed warning buzzer 98 may be mounted at any location, but for example, if the speed warning buzzer 98 is mounted on the back of the back pad 39, as shown in FIG. 3, a dead space can be utilized, and it is possible to cause a rider to reliably hear a warning sound, which is preferred.

A backward-movement brake circuit 100 is connected between a plus terminal and a minus terminal of the electric generator/motor 61. The backward-movement brake circuit 100 is comprised of a diode 102 inserted into an electric path 101 connecting the plus and minus terminals to each other. The diode 102 permits the flowing of electric current from the minus terminal to the plus terminal.

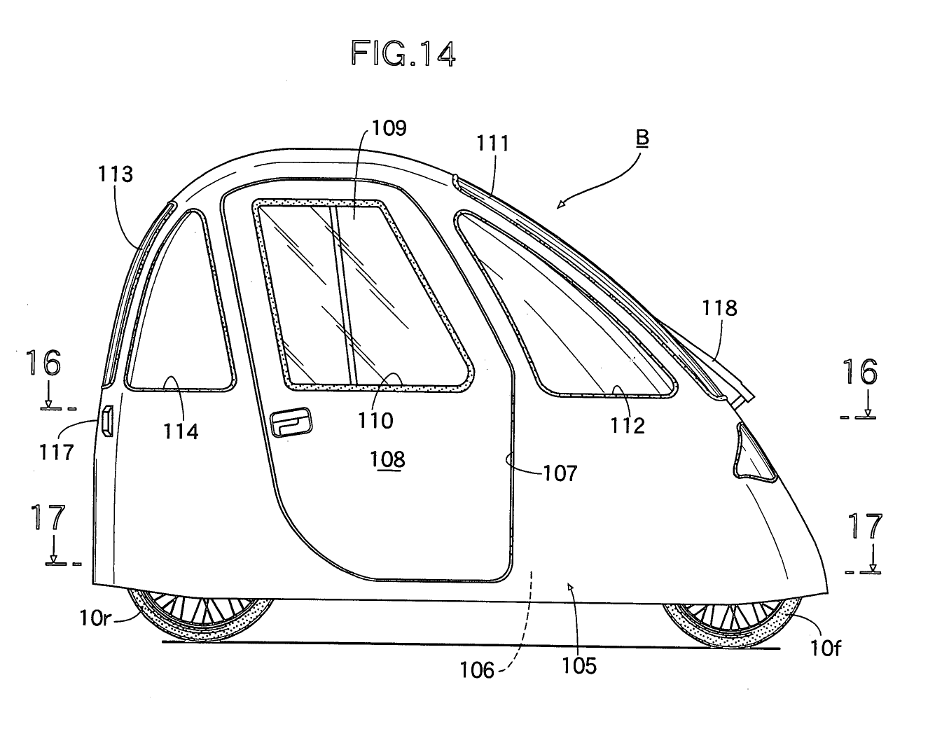

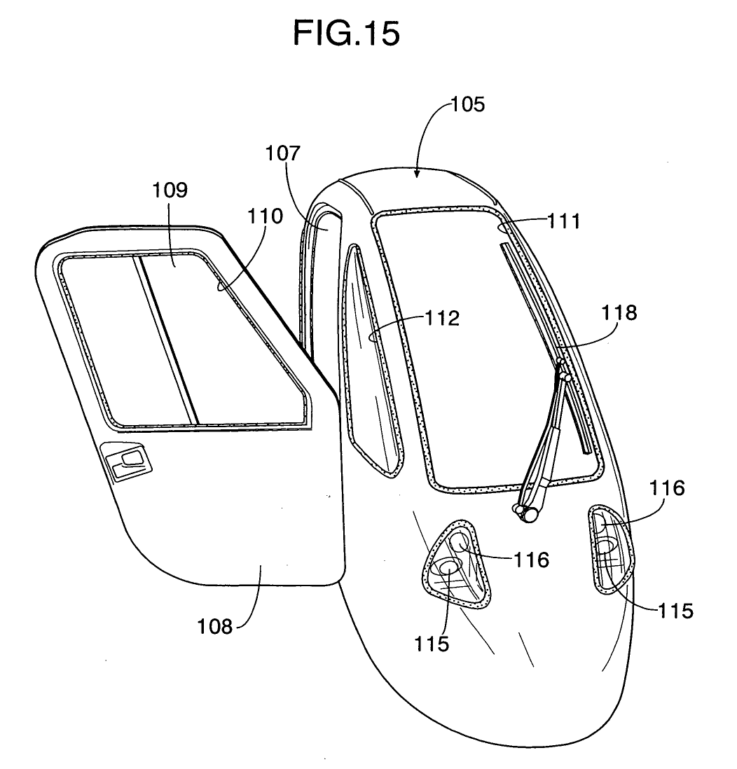

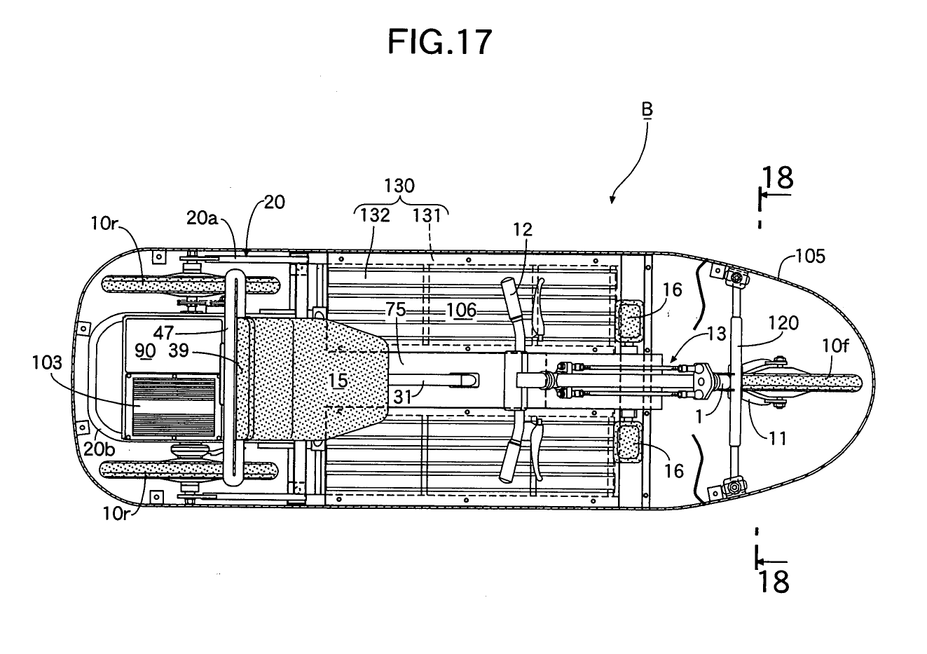

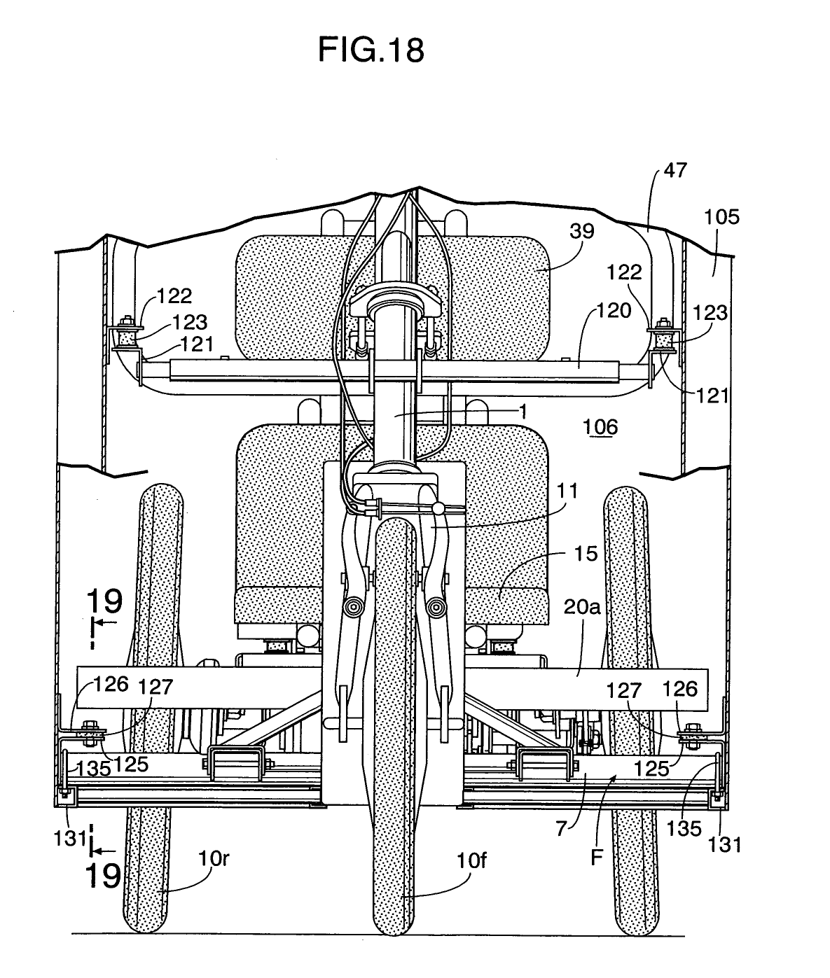

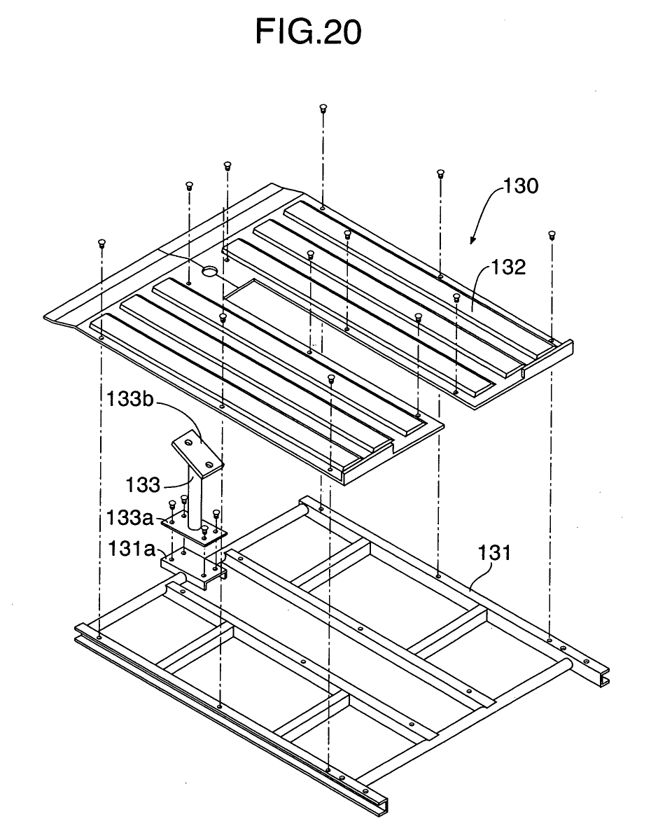

Referring to FIGS. 14 to 20, a vehicle body shell 105 made of a synthetic resin (e.g., FRP or ABS) is mounted to the vehicle body frame F to cover the entire electrically-assisted cycle B from above, and the inside of the vehicle body shell 105 serves as a cabin 106 for accommodation of a rider. The vehicle body shell 105 is of a streamline shape with a lower surface opened. Doorways 107, 107 are provided in opposite sidewalls of the vehicle body shell 105, and doors 108, 108 for opening and closing the doorways 107, 107 are supported at their front ends on the opposite sidewalls of the vehicle body shell 105. Each of the doors 108 is also made of a synthetic resin and has a side window 110 capable of being opened and closed by a transparent slide plate 109. The vehicle body shell 105 is also provided with a front window 111, left and right front quarter windows 112, a rear window 113, and left and right rear quarter windows 114, into each of which a transparent shield plate is fitted, and a wiper 118 for wiping a shield plate surface of the front window 111 is mounted on the vehicle body shell 105. Further, a head light 115 and left and right winker lamps 116, 116 are mounted at a front portion of the vehicle body shell 105, and left and right winker lamps 117, 117 are mounted at a rear portion of the vehicle body shell 105.

In order to mount the vehicle body shell 105 to the vehicle body frame F, a support rod 120 is fixedly mounted on the front head pipe 1 to protrude laterally outside the front head pipe 1. The support rod 120 is provided at its opposite ends with L-shaped front connecting members 121, 121. The cross pipe 7 is also provided at its opposite ends with L-shaped rear connecting members 125, 125. L-shaped front connecting members 122, 122 fixedly mounted on left and right inner walls of the front portion of the vehicle body shall 105 are coupled to the L-shaped front connecting members 121, 121 by bolts with elastic members 123 interposed therebetween, and L-shaped rear connecting members 126, 126 fixedly mounted on left and right inner walls of the rear portion of the vehicle body shall 105 are coupled to the L-shaped rear connecting members 125, 125 by bolts 128 with elastic members 123 interposed therebetween. In this manner, the vehicle body shell 105 is mounted to the vehicle body frame F, so that the vibration between the vehicle body frame F and the vehicle body shell 105 is absorbed into the elastic members 123 and 127.

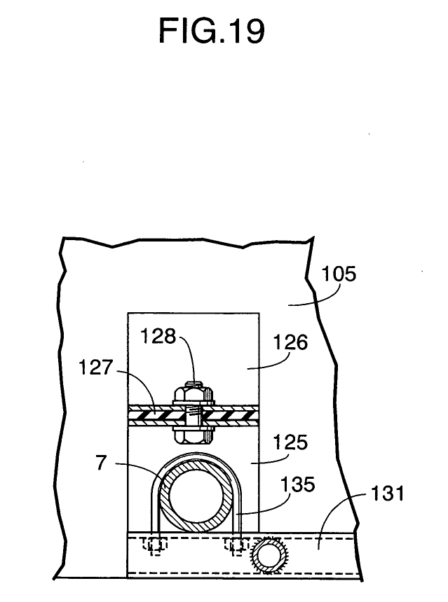

A floor 130 is mounted to the vehicle body frame F to close a central portion of an opened lower surface of the vehicle body shell 105. The floor 130 comprises a lattice-shaped floor frame 131, and a floor plate 132 divided laterally and joined to an upper surface of the floor frame 131. A support pillar 133 is mounted on an upper surface of a front end of the floor frame 131 to rise through the floor plate 132. In this case, a connecting flange 133a formed at a lower end of the support pillar 133 is bolted to a lower flange 131a fixedly provided on the upper surface of the front end of the floor frame 131. An upper flange 133b formed at an upper end of the support pillar 133 is also bolted to a bracket 134 (see FIG. 1) fixedly mounted on the inclined section 2a of the main pipe 2. Left and right rear ends of the floor frame 131 are secured to left and right opposite ends of the cross pipe 7 through U-bolts 135 (particularly see FIG. 19). The floor plate 132 is provided with a notch 136 for avoiding the interference with the chain cover 75. In this manner, the floor is removably secured to the vehicle body frame F.

A front cover 137 is removably connected to the front end of the floor plate 132 and the inner wall of the vehicle body shell 105 for covering an upper portion and a back of the front wheel 10f and closing the opened lower surface of the vehicle body shell 105, as clearly shown in FIG. 1, and a rear cover 138 is removably connected to the rear end of the floor plate 132 and the inner wall of the vehicle body shell 105 for covering the battery 90 and the electric circuit assembly 103 from above in addition to the left and right rear wheels 10r, 10r and closing the rear portion of the opened lower surface of the vehicle body shell 105, as clearly shown in FIG. 1.

In this manner, the cabin 106 within the vehicle body shell 105 is maintained in a substantially closed state by the floor 130, the front cover 137 and the rear cover 138. Therefore, it is possible to prevent the entrance of wind and rain into the cabin 106 and hence, to protect the rider from the cold even in the winter season. In addition, by removing one or both of the front cover 137 and the rear cover 138 or removing all of the floor 130 and the covers 137 and 138, travel wind can be introduced moderately into the cabin 106 from below the vehicle body shell 105 to enable the refreshing driving even in the summer season. Further, the rear cover 138 for covering the rear wheels 10r, 10r also serves a cover for covering the battery 90 and the electric circuit assembly 103 and therefore, a cover for the exclusive use of the battery 90 and the electric circuit assembly 103 is not required, and the appearance within the cabin can be made nice in a simple structure.

The operation of this embodiment will be described below.

### Electrically Assisted Traveling

First, the clutch-operating lever 72 is set in the turned-on position to bring the clutch 46 into the connected state, and the assisting/charging mode changeover switch 92 is then changed over to the assisting side. Thus, the mode switchover drive circuit 91 is brought into the electrically assisting mode by the electronic control circuit system 99 and hence, the electric generator/motor 61 is supplied with an electric power from the battery 90 in accordance with the pedal load. If a rider drives the pedals 16, 16 at that time, the driving force is transmitted to the rear wheels 10r sequentially via the first chain gearing device 41, the second chain gearing device 42, the transmission 45, the third chain gearing device 43, the rotor shaft 61a, the clutch 46 and the fourth chain gearing device 44. During this time, the electronic control circuit system 99 controls the amount of power supplied to the electric generator/motor 61 from the battery 90 in response to the pedal load signal input from the pedal load sensor 60. Therefore, the electric generator/motor 61 generates a power depending on the pedal load from the rotor shaft 61a, and this power is transmitted to the transmitting device M and added to the driving force provided by the rider. Thus, the rider can drive the crankshaft 17 lightly through the pedals 16, 16 to cause the electrically-assisted cycle B to travel.

### Control of Vehicle Speed

If the vehicle speed is increased to exceed the first predetermined value during traveling of the cycle, for example, on a downward slope, the electronic control circuit system 99 sounds the speed warning buzzer 98 to urge the rider for a braking operation. If the vehicle speed is further increased to exceed the second predetermined value larger than the first predetermined value, the electronic control circuit system 99 actuates the brake motor 87 to automatically actuate the rear brake 81. Therefore, even with the electrically-assisted cycle B provided with the vehicle body shell 105 having a large weight, an excessive increase in the vehicle speed thereof can be suppressed reliably, and an increase in braking distance during sudden braking can be suppressed to the utmost.

Particularly, the sounding of the speed warning buzzer 98 prior to the actuation of the brake motor 87 is effective for suppression of the excessive increase in vehicle speed, because it causes the rider to expect the automatic actuation of the brake motor 87 and positively urges the rider for the braking operation.

### Physical Strength Promoting Travel Training

The clutch operating lever 72 is set in the turned-on position as in the above-described case to maintain the clutch 46 in the connected state, and the assisting/charging mode change over switch 92 is changed over to the charging side. Thus, the mode switchover drive circuit 91 is brought into the charging mode by the electronic control circuit system 99 and hence, the electric generator/motor 61 can generate a power under reception of a back load to charge the battery 90. If the rider drives the crankshaft 17 through the pedals 16, 16 at that time, the driving force is transmitted to the rear wheels 10r sequentially via the first chain gearing device 41, the second chain gearing device 42, the transmission 45, the third chain gearing device 43, the rotor shaft 61a, the clutch 46 and the fourth chain gearing device 44 to drive the rear wheels 10r, and at the same time, the electric generator/motor 61 is brought into a power-generating state by the rotation of the rotor shaft 61a to charge the battery 90. A load generated with such generation of an electric power is applied to the pedal load provided by the rider, whereby the rider can conduct the physical strength promoting training, while driving the cycle B to travel and at the same time, can perform the charging of the battery 90. In this case, when the pedal load adjusting dial 93 is rotated in a decreasing or increasing direction, the amount of power charged in the battery 90 from the electric generator/motor 61 is controlled to be increased or decreased depending on such direction of the rotation, whereby the magnitude of the pedal load can be adjusted freely. Therefore, the pedal load can be adjusted freely in accordance with the physical strength, the degree of fatigue or the like of the rider, and thus, the training can be conducted comfortably and without strain.

### Suppression of Acceleration of Rearward Movement

In the case of either [Electrically-assisted travel] or [Physical strength promoting travel training], when the electrically-assisted cycle B starts to be moved backwards in an upward slope because of the weak strength of legs of a rider, the rotor shaft 61a of the electric generator/motor 61 is reversed, whereby the polarity of the plus terminal is reversed to minus (−), and the polarity of the minus terminal is reversed to plus (+) by the voltage generated by the motor 61. Therefore, in the backward movement brake circuit 100, the diode 102 is brought into a connected state and hence, the electric generator/motor 61 is brought into an electrically short-circuited state to generate a large braking torque, whereby the acceleration of the backward movement of the electrically-assisted cycle B can be suppressed effectively. In the backward movement brake circuit 100 in this embodiment, the arrangement is extremely simple, because the electric generator/motor 61 can be brought into the electrically short-circuited state upon the backward movement of the electrically-assisted cycle B without use of a sensor for specially detecting the backward movement.

### Physical Strength Promoting Fixed-Position Training

First, the parking lever 83 is operated to bring the front brake 80 into an actuated state, and the clutch lever 72 is operated into the turned-off position to bring the clutch 46 into the disconnected state; and the assisting/charging mode changeover switch 92 is changed over to the charging side. Then, as in the case of [Physical strength promoting travel training], the mode switchover drive circuit 91 is brought into the charging mode by the electronic control circuit system 99. Therefore, the electric generator/motor 61, if it receives a back load, generates a power to enable the charging of the battery 90. If the rider drives the crankshaft 17 through the pedals 16, 16 at that time, the driving force is transmitted to the rotor shaft 61a via the first chain gearing device 41, the second chain gearing device 42, the transmission 45 and the third chain gearing device 43, but is not transmitted to the fourth chain gearing device 44 because of the disconnection of the clutch 46. Therefore, the back load is applied to the electric generator/motor 61 by the driving of the pedals 16, 16 with the rear wheels 10r remaining stopped and hence, the electric generator/motor 61 is brought into the power-generating state to charge the battery 90. A load generated with the generation of the power is applied to the pedal load provided by the rider, whereby the rider can conduct the physical strength promoting training and at the same time, can perform the charging of the battery 90. Even in this case, when the pedal load adjusting dial 93 is rotated in a decreasing or increasing direction, the amount of power charged in the battery 90 from the electric generator/motor 61 is controlled to be increased or decreased depending on such direction of the rotation, whereby the magnitude of the pedal load can be adjusted freely. Even in this case, the pedal load can be adjusted freely in accordance with the physical strength, the degree of fatigue or the like of the rider, and thus, the training can be conducted comfortably and without strain.

In this case, the cycle B is retained in a fixed-position state by the operation of the parking lever 83 and moreover, is the three-wheel type cycle having the single front wheel lOf and the two rear wheels 10r and is capable of standing by itself without use of a special stand device. Therefore, the cycle B can be used safely as a fixed-position training machine for promoting the physical strength without limitation of the placing area to a garage and a garden of a rider's house or the like, and moreover, a kinetic energy of the rider is converted into an electric power to be charged in the battery, leading to no wastefulness of energy.

In addition, the cabin 106 for accommodation of a rider is designed so that the entrance of wind and rain into the cabin 106 is prevented by the vehicle body shell 105, the floor 130, the front cover 137 and the rear cover 138 to protect the rider. Moreover, in the three-wheel type cycle B capable of standing by itself, the rider does not need to put his feet onto a road surface even at stoppage of the cycle B and hence, the feet cannot be exposed to wind and rain. Therefore, the comfortable traveling and training are possible irrespective of the weather.

Further, the opening of the door 108 enables the rider to make entrance and exit into and from the cabin 106 through the doorway 107 in a feeling similar to the case of an automobile.

In the three-wheel type assisted cycle B having such a physical strength promoting function, the steering handlebar 12 is disposed in front of and above the saddle 15 having the back pad 39 and disposed below the upper surfaces of the rear wheels 10r, 10r, and the axis of the crankshaft 17 is disposed in front of and above the saddle 15 and below the steering handlebar 12. Therefore, the rider can lower the center of gravity of the electrically-assisted cycle B sufficiently in a state in which the rider is sitting on the saddle 15, thereby lowering the height of the vehicle body shell 105 having the relatively large weight sufficiently. Therefore, it is possible to lower the center of gravity of the three-wheel type cycle B sufficiently to enhance the driving stability.

As a result of the above-described disposition of the saddle 15 and the crankshaft 17, to drive the crankshaft 17, the rider pushes the pedals 16, 16 forwards. Therefore, the force of the rider's legs can be transmittedwithagood efficiency to the pedals 16, 16 irrespective of the magnitude of the rider's weight to rationally conduct the training for strengthening the rider's waste and legs.

In this case, if the clamper 35 of the saddle 15 is loosened and the saddle 15 is slid longitudinally along the saddle guide rail 31, not only the longitudinal distance and the vertical distance between the saddle 15 and the steering handlebar 12 but also the longitudinal distance and the vertical distance between the saddle 15 and the axis of the crankshaft 17 can be simultaneously adjusted to be increased or decreased, because the saddle guide rail 31 is inclined upwards in the forward direction, as described above. For example, when the saddle 15 is slid forwards along the saddle guide rail 31, the longitudinal distance and the vertical distance between the saddle 15 and the steering handlebar 12 as well as the longitudinal distance and the vertical distance between the saddle 15 and the axis of the crankshaft 17 can be decreased simultaneously. Therefore, the saddle 15 can be adjusted to properly correspond to any of different physiques of riders, thereby ensuring a good steerability.

After the above-described adjustment of the saddle 15, the damper 35 is tightened. This tightening causes the left and right clamping plates 34, 34 to be brought into pressure contact with the opposite sides of the saddle guide rails 31 square in section, whereby not only the sliding of the saddle 15 on the saddle guide rail 31 but also the rotation of the saddle 15 about the axis of the saddle guide rail 31 can be inhibited, and the fixing of the saddle 15 can be achieved easily andreliably. Especially, the saddle guide rail 31 is formed of the single square pipe to inhibit the rotation of the saddle 15, which can largely contribute to a decrease in number of parts and a reduction in weight of the cycle.

In the disconnected state of the clutch 46, if all of the front brake 80 and the rear brake 81 are brought into inoperative states, the forward and backward movements of the electrically assisted cycle B can be conducted freely by hand-pushing without being resisted by the electric generator/motor 61, leading to a good manipulability.

In the rear wheel suspension S, when a vertical load applied to the vehicle body frame F or the rear wheels 10r, 10r is changed, the swing arm 20 is vertically swung about the pivots 26, 26 relative to the suspension arms 9, 9. Therefore, in each of the cushion blocks 21, the upper mounting member 28 and the lower mounting members 29, 29 are vertically moved relative to each other to elastically deform the cushion member 30 in a shearing direction. The vertical load applied to the vehicle body frame F or the rear wheels 10r, 10r is supported by a shearing stress generated in the cushion member 30 at that time, and the vertical swinging of the rear wheels 10r, 10r is absorbed effectively by the shearing deformation of the cushion member 30. This can provide a good riding comfort to the rider.

The axles 23, 23 of the left and right rear wheels 10r, 10r are separated and independent from each other, but the left and right rear forks 22, 22 supporting the axles 23, 23 respectively are integrally connected to each other and hence, can function as stabilizers for suppressing the independent vertical movements of the rear wheels 10r, 10r. Therefore, even when the outer rear wheel 10r is lifted relative to the vehicle body frame F, while deforming the cushion member 30 of the corresponding cushion block 21, due to a centrifugal force acting on the system of the vehicle body frame F during turning of the cycle B, the inner rear wheel 10r is also lifted simultaneously and thus, the cycle B can be maintained at a stable turning attitude. In addition, the left and right pivots 26, 26 of the left and right rear forks 22, 22 are disposed in an inside region between the left and right rear wheels 10r, 10r and hence, despite the placement of the pivots 26, 26, it is possible to suppress increases in entire length and lateral width of the cycle B, which can contribute to the compactness of the cycle B. Further, the suspension arms 9, 9 at the rear end of the vehicle body frame F are disposed below the rear forks 22, 22 in an area of mounting of the cushion blocks 21, 21. Therefore, the saddle 15 can be placed easily on the vehicle body frame F below the upper surfaces of the rear wheels 10r, 10r adjacent the rear wheels 10r, 10r, whereby the lowering of the center of gravity of the cycle B can be provided effectively.

The present invention is not limited to the above-described embodiment, and various modifications in design may be made in a scope which does not depart from the subject matter of the present invention. For example, the three-wheel type electrically-assisted cycle B can be constructed into a type having two front wheels 10f and a single rear wheel 10r. In addition, a thyristor, IGBT, FET and another semiconductor can be substituted for the diode 102 in FIG. 13.

What is claimed is

1. An electrically-assisted cycle having a physical strength promoting function, comprising a transmitting device (m) which connects a crankshaft (17) having pedals (16) driven by a rider and a rear wheel (10r) to each other, a battery (90), an electric generator/motor (61) having a rotor shaft (61a) connected to the transmitting device (m), a mode switchover means (91, 92, 99) capable of being switched over, as described, between an electrically assisting mode in which a power is generated in the electric generator/motor (61) by supplying of an electric power from the battery (90) and a charging mode in which the electric power generated in the electric generator/motor (61) due to a back load to the rotor shaft (61a) is charged in the battery (90), and a clutch (46) capable of opening and closing a transmitting path between the electric generator/motor (61) and the rear wheel (10r) as desired:

2. An electrically-assisted cycle having a physical strength promoting function according to claim 1, further including
a pedal load adjusting means (93) capable of adjusting a pedal load provided by the rider by increasing or decreasing the amount of power charged in the battery (90) from the electric generator/motor (61), when the mode switchover means (91, 92, 99) is switched over to the charging mode.

3. An electrically-assisted cycle having a physical strength promoting function according to claim 1 or 2, wherein
a vehicle body shell (105) is mounted to a vehicle body frame (F) to define a cabin (106) for accommodation of the rider.
